(19) United States
(12) Patent Application Publication
(10) Pub. No.: US 2008/0009431 A1
(43) Pub. Date: Jan. 10, 2008

(54) Enzyme stabilization

(76) Inventors: Jean-Pol Boutique, Gembloux (BE); Ander Cesar Baeck, Bonheiden (BE); Nathalie Jean Marie-Louise Vanwyngaerden, Leuven (BE); Garry Steven Garrett, Fairfield, OH (US); Charles Winston Saunders, Fairfield, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/810,208

(22) Filed: Jun. 5, 2007

Related U.S. Application Data
(60) Provisional application No. 60/810,909, filed on Jun. 5, 2006.

(51) Int. Cl. C11D 7/42

(52) U.S. Cl. 510/393

(57) ABSTRACT

Liquid detergent compositions comprising a reversible peptide protease inhibitor are provided. Methods of using the reversible peptide protease inhibitor to stabilize liquid detergent compositions are also provided.

### CROSS REFERENCE TO RELATED APPLICATION

This application claims the benefit of U.S. Provisional Application Ser. No. 60/810,909, filed Jun. 5, 2006.

### FIELD OF THE INVENTION

The present invention is directed to enzyme stabilization systems as well as methods of using and compositions containing the same.

### BACKGROUND OF THE INVENTION

Protease-containing liquid compositions are well-known, especially in the context of laundry washing. A commonly encountered problem in such protease-containing liquid compositions is the degradation phenomenon by protease enzyme of second enzymes in the composition, such as amylase, lipase and cellulase, or on the protease itself. As a result, the stability of the second enzyme or the protease itself in the liquid composition is affected and the composition consequently performs less well.

In response to this problem, it has been proposed to use various protease inhibitors or stabilizers. For instance, references have proposed the use of compounds, such as the following to aid in the stabilization of enzymes: benzamidine hydrochloride, lower aliphatic alcohols or carboxylic acids, certain peptide aldehydes, mixtures of polyol solvents and boron compounds, magnesium and/or calcium salts (such as calcium formate).

Although these compounds have been used to varying success in liquid compositions, they are not free of problems. For example, they can be rather expensive and/or create complexities for the formulators, especially for liquid detergents. Other inhibitors or stabilizers are less expensive to use but do not stabilize enzymes sufficiently. Thus the need remains for a protease inhibitor which is economical, effective and suitable for use in a liquid composition, such as, a liquid laundry composition.

### SUMMARY OF THE INVENTION

One aspect of the invention relates to a liquid detergent composition comprising:

(a) a surfactant;

(b) a protease enzyme;

(c) a reversible peptide protease inhibitor of the formula: 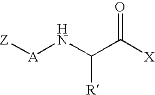
wherein A is an amino acid moiety; X is selected from H, an electron withdrawing group and mixtures thereof; Z is a nitrogen capping moiety selected from: 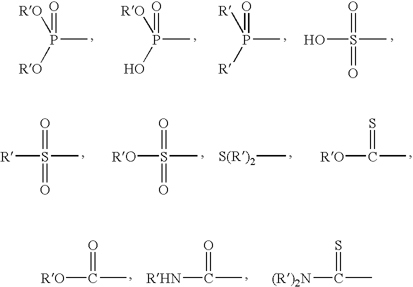
and mixtures thereof, wherein each R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof; and
wherein the liquid detergent composition comprises less than about 3%, by weight of the composition, of organic polyol solvents.

Another aspect of the invention relates to a liquid detergent composition comprising:

(a) a surfactant;

(b) a protease enzyme;

(c) an enzyme stabilization system, wherein the enzyme stabilization system comprises: a first reversible peptide protease inhibitor of the formula: 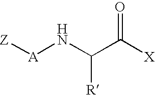
wherein A, X, Z and R′ are as described herein; and an aromatic protease inhibitor of the formula: 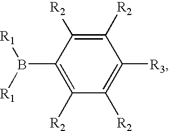
wherein each R₁ is independently selected from hydroxy; linear or branched, substituted or unsubstituted C₁-C₆ alkoxy; and mixtures thereof; each R₂ is independently selected from the group consisting of hydrogen; hydroxy; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; and mixtures thereof; R₃ is selected from the group consisting of hydrogen; hydroxyl; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; C(O)—R₄ and mixtures thereof, and R₄ is selected from hydrogen; hydroxyl; linear or branched, substituted or unsubstituted C₁-C₆ alkyl; linear or branched, substituted or unsubstituted C₁-C₆ alkoxy and mixtures thereof; and
wherein the liquid detergent composition comprises less than about 3%, by weight of the composition, of organic polyol solvents.

In a further aspect the invention relates to a liquid detergent composition comprising:

(a) a surfactant;

(b) a protease enzyme;

(c) a reversible peptide protease inhibitor of the formula: 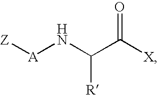
wherein A, X, Z and R′ are as described herein;
wherein the liquid detergent composition comprises at least one of:
(i) less than about 1%, by weight of the composition, of organic polyol solvents;
(ii) more than about 60% water;
(iii) a thickener; and/or
(iv) less than about 1%, by weight of the composition, of boric acid.

### DETAILED DESCRIPTION OF THE INVENTION

Definitions—As used herein, “liquid detergent composition” refers to any laundry treatment composition which is not in solid, i.e., tablet or granule, or gas, form. Examples of liquid laundry detergent compositions include heavy-duty liquid laundry detergents for use in the wash cycle of automatic washing-machines, liquid finewash and liquid color care detergents such as those suitable for washing delicate garments, e.g., those made of silk or wool, either by hand or in the wash cycle of automatic washing-machines. The corresponding compositions having flowable yet stiffer consistency, known as gels, are likewise encompassed. Other liquid or gel-form laundry treatment compositions encompassed herein include dilutable concentrates of the foregoing compositions, unit dose, spray, pretreatment (including stiff gel stick) and rinse laundry treatment compositions, or other packaged forms of such compositions, for example those sold in single or dual-compartment bottles, tubs, or polyvinyl alcohol sachets and the like. The compositions herein suitably have a sufficiently fluid rheology that they may be dosed either by the consumer, or by automated dosing systems controlled by domestic or commercial laundry appliances. Stiff gel forms may be used as pretreaters or boosters, see for example US20040102346A1, or may be dispensed in automatic dispensing systems, for example through being dissolved in-situ in the presence of a stream of water.

In general, the compositions herein may be isotropic or non-isotropic. However, they do not generally split into separate layers such as phase split detergents described in the art. One illustrative composition is non-isotropic and on storage is either (i) free from splitting into two layers or, (ii) if the composition splits into layers, a single major layer is present and comprises at least about 90% by weight, more specifically more than about 95%, even more specifically more than about 99% of the composition. Other illustrative compositions are fully isotropic.

“Gel” as used herein includes a shear thinning gel with a pouring viscosity in the range of from 1,000 to 5,000 mPas (milli Pascal seconds), more specifically less than 3,000 mPas, even more specifically less than 1,500 mPas. Gels include thick liquids. More specifically, a thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick under low shear (e.g., at rest) and thin at high flow rates. The rheology of shear-thinning gels is described in more detail in the literature, see for example WO04027010A 1 Unilever.

Other illustrative compositions according to the present invention are pourable gels specifically having a viscosity of at least 1,500 mPa·s but no more than 6,000 mPa·s, more specifically no more than 4,000 mPa·s, even more specifically no more than 3,000 mPa·s and even more specifically still no more than 2,000 mPa·s.

Yet other illustrative compositions according to the present invention are non-pourable gels specifically having a viscosity of at least 6,000 mPa·s but no more than 12,000 mPa·s, more specifically no more than 10,000 mPa·s, even more specifically no more than 8,000 mPa·s and even more specifically still no more than 7,000 mPa·s.

Illustrative specific liquid or gel form laundry treatment compositions herein include heavy-duty liquid laundry detergents for use in the wash cycle of automatic washing-machines and liquid finewash and/or color care detergents. These suitably have the following rheological characteristics: viscosity of no more than 1,500 mPa·s, more specifically no more than 1,000 mPa·s, still more specifically, no more than 500 mPa·s. In one embodiment, these compositions have a viscosity of from 30 to 400 mPas and are either Newtonian or shear-thinning. In these definitions and unless specifically indicated to the contrary, all stated viscosities are those measured at a shear rate of 21 s⁻¹ and at a temperature of 25° C. Viscosity herein can be measured with any suitable instrument, e.g., a Carrimed CSL2 Rheometer at a shear rate of 21 sec⁻¹.
Reversible peptide protease inhibitor—The stabilizing enzymes of the present invention comprise a reversible peptide protease inhibitor of the formula:

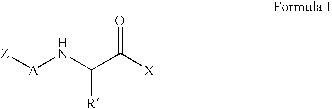

In the reversible peptide protease inhibitor, A is an amino acid moiety. In one optional embodiment of the amino acid moiety is composed of one or more amino acids, selected from alanine (Ala), arginine (Arg), asparagine (Asn), aspartic acid (Asp), cysteine (Cys), glutamine (Gln), glutamic acid (Glu), glycine (Gly), histidine (His), homophenylalanine (HPhe), isoleucine (Ile), leucine (Leu), lysine (Lys), methionine (Met), phenyalanine (Phe), phenylglycine (PGly), proline (Pro), serine (Ser), threonine (Thr), tryptophan (Trp), tyrosine (Tyr) and valine (Val).

In one embodiment, A comprises one or more, preferably from one to four of alanine, glycine, leucine, valine, isoleucine, proline, lysine, phenylalanine, homophenylalanine, phenylglycine, tryptophan, glycine, arginine and methionine, even more specifically still valine and alanine.

The amino acid moiety may be any suitable optical isomer, that is, the amino acid moiety may be optically active in either the L or D configuration or combinations thereof, or be optically inactive or be a racemic mixture. Similarly, the individual amino acids that comprise the amino acid moiety and/or the reversible peptide protease inhibitor may be optically active in either the L or D configuration or combinations thereof, or be optically inactive or be a racemic mixture.

In Formula I, X is H, an electron withdrawing group and mixtures thereof. Non limiting examples of suitable electron withdrawing groups include, but are not limited to, CF₂H, CH₂F, CF₂—R CHF—R, CO₂—R, CH₂Cl, substituted or unsubstituted imidazoles, substituted or unsubstituted thioamidazoles, substituted or unsubstituted benzimidazoles, and mixtures thereof, wherein R is selected from the group consisting of linear or branched, substituted or unsubstituted C₁-C₆ alkyl; and linear or branched substituted or unsubstituted C₄-C₈ cycloalkyl moieties; and mixtures thereof.

In Formula I, Z is a N-capping moiety selected from: 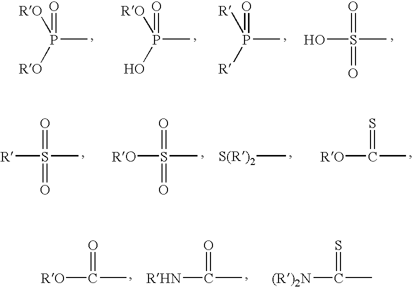
and mixtures thereof, more specifically, 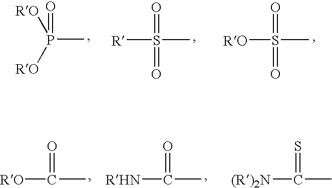
and mixtures thereof; and even more specifically 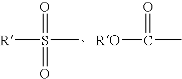
and mixtures thereof.

R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof, more specifically linear or branched, C₁-C₆ alkyl; phenyl; linear or branched, C₇-C₉ alkylaryl; and mixtures thereof, and even more specifically, linear or branched, C₁-C₆ alkyl; linear or branched substituted or unsubstituted C₅-C₉ alkylheterocyclic; and mixtures thereof.

Nonlimiting illustrative examples of suitable reversible peptide protease inhibitors include: 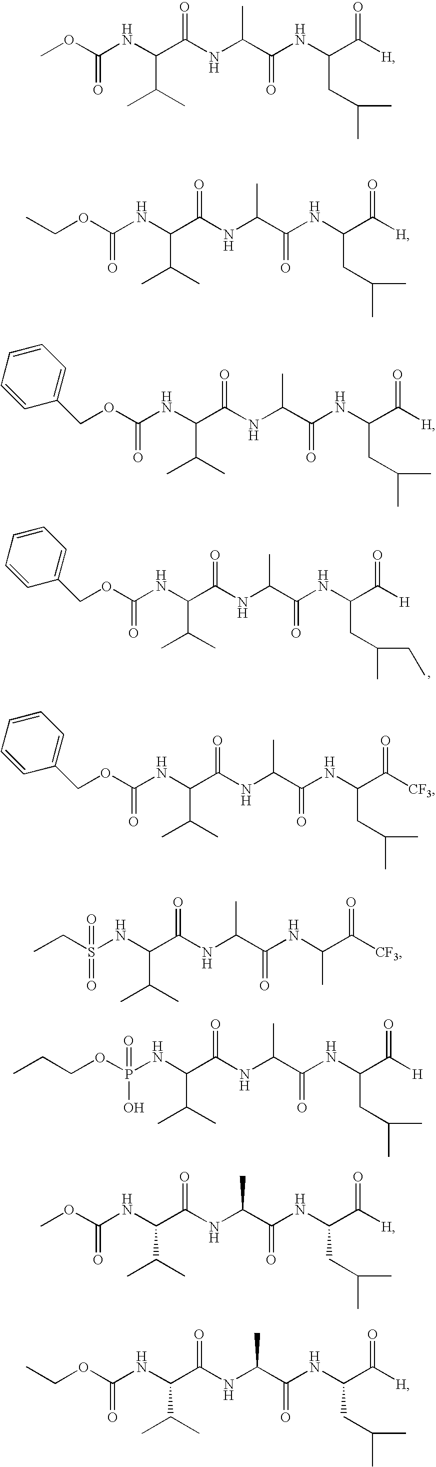 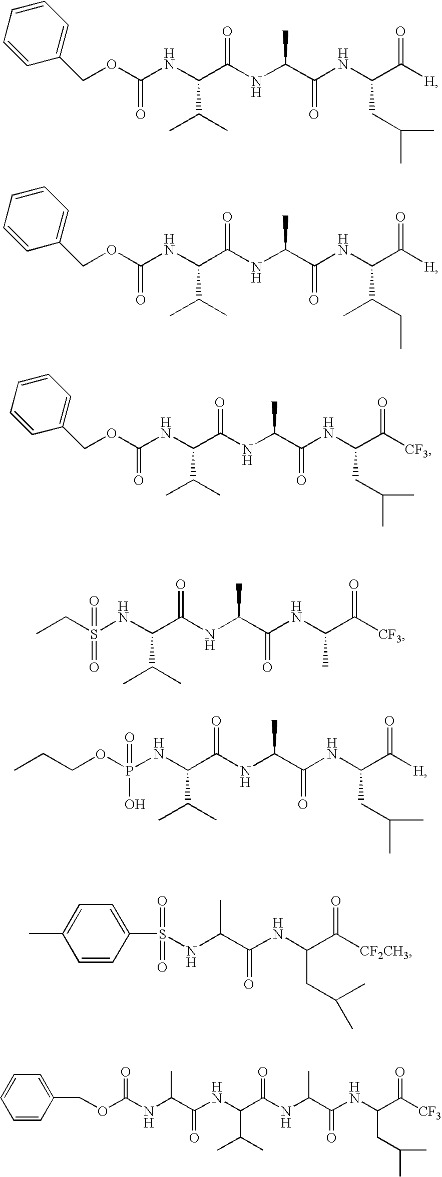
and mixtures thereof.

The reversible peptide protease inhibitor may be made in any suitable manner. Illustrative examples of suitable process for the manufacture of the reversible peptide protease inhibitor may be found in U.S. Pat. No. 6,165,966.

In one embodiment, the composition comprises, from about 0.00001% to about 5%, specifically from about 0.00001% to about 3%, more specifically from about 0.00001% to about 1%, by weight of the composition, of the reversible peptide protease inhibitors.

Organic Polyol Solvents—In one embodiment, the liquid detergent composition and methods of the present invention may comprise less than about 5%, by weight of the detergent composition, specifically less than about 3%, by weight of the detergent composition, more specifically still less than about 1%, by weight of the detergent composition, even more specifically is substantially free of organic polyol solvents. By “substantially free of organic polyol solvents” it is meant that more specifically no organic polyol solvents are purposefully added to the formulation, but yet it is understood to one of ordinary skill in the art that trace amounts of organic polyol solvents may be present as impurities or as process/stability aids in other additives, i.e. the composition contain less than about 0.1%, by weight of the composition of organic polyol solvents.

By “organic polyol solvents”, it is meant low molecular weight organic solvents composed of carbon, oxygen and hydrogen atoms, and comprising 2 or more hydroxyl groups, such as ethanediol, 1,2 and 1,3 propanediol, glycerol, glycols and glycolethers, sorbitol, mannitol, 1,2 benzenediol, and mixtures thereof. This definition especially encompasses the diols, especially the vicinal diols that are capable of forming complexes with boric acid and borate to form borate esters.

Boric acid derivatives—In another embodiment, the compositions and methods of the present invention, may comprise less than about 5%, by weight of the detergent composition, specifically less than about 3%, by weight of the detergent, composition, more specifically less than about 1%, by weight of the detergent composition, even more specifically is substantially free of boric acid derivatives. By “substantially free of boric acid derivatives” it is meant that more specifically no boric acid derivatives are purposefully added to the formulation, but yet it is understood to one of ordinary skill in the art that trace amounts of boric acid derivatives may be present as impurities or as process/stability in other additives, i.e. the composition contain less than about 0.1%, by weight of the composition of boric acid derivatives.

By “boric acid derivatives” it is meant boron containing compounds such as boric acid per se, substituted boric acids and other boric acid derivatives that at least a part of which are present in solution as boric acid or a chemical equivalent thereof, such as a substituted boric acid. Illustrative, but non-limiting examples of boric acid derivatives includes, boric acid, boric oxide, borax, alkali metal borates (such as sodium ortho-, meta- and pyroborate and sodium pentaborate), and mixtures thereof.

As noted herein, these boric acid derivatives have in the past been used in combination with organic polyol solvents as a protease enzyme stabilization system. The selection of a reversible peptide protease inhibitor means that the use of these boric acid derivatives can be reduced, thereby saving money and time.

Protease Enzmme—The compositions and methods of the present invention comprise one or more protease enzymes. In one embodiment, the compositions and methods of the present invention include a protease enzyme from about 0.0001% to about 5%, specifically from about 0.001% to about 2%, more specifically from about 0.001% to about 1%, even more specifically from about 0.001% to about 0.2%, even more specifically still from about 0.005% to about 0.1%, by weight of the detergent composition, of a protease enzyme.

Any protease suitable for use in detergents can be used. Such proteases can be of animal, vegetable or microbial origin, with both modified (chemical or genetically variants) and unmodified proteases included.

One class of suitable proteases are the so-called serine endopeptidases [E.C. 3.4.21] and an example of which are the serine protease [E.C. 3.4.21.62]. Illustrative non-limiting examples of serine proteases includes subtilisins, e.g. subtilisins derived from Bacillus (e.g. B. subtilis, B. lentus, B. licheniformis, B. amyloliquefaciens, B. alcalophilus), for example, subtilisins BPN and BPN′, subtilisin Carlsberg, subtilisin 309, subtilisin 147, subtilisin 168, subtilisin PB92, their mutants and mixtures thereof.

Illustrative non-limiting examples of commercially available serine proteases, include, Alcalase®, Savinase®, Kannase®, Everlase® available from Novozymes; Purafect®, Purastar OxAm®, Properase® available from Genencor; BLAP and BLAP variants available from Henkel; and K-16-like proteases available from KAO. Additional illustrative proteases are described in e.g. EP130756, WO91/06637, WO95/10591, WO99/20726, U.S. Pat. No. 5,030,378 (Protease “A”) and EP251446 (Protease “B”).
Reversible aromatic protease inhibitor—In another embodiment the liquid detergent composition may comprise a reversible aromatic protease inhibitor of the formula: 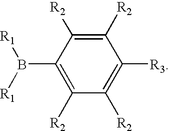
It is important to note that the B in the reversible aromatic protease inhibitor formula represents the element Boron and not a markush group. Each R₁ is independently selected from, hydroxy; linear or branched, substituted or unsubstituted C₁-C₆ alkoxy, more specifically hydroxyl, linear or branched, C₁-C₆ alkoxy and mixtures thereof, even more specifically hydroxy; linear or branched, C₁-C₃ alkoxy; each R₂ is independently selected from hydrogen; hydroxyl; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; and mixtures thereof, more specifically hydrogen, hydroxyl, linear or branched, C₁-C₆ alkyl; and mixtures thereof, even more specifically hydrogen, hydroxyl and mixtures thereof; and R₃ is selected from hydrogen; hydroxyl; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; C(O)—R₄ and mixtures thereof, more specifically, hydroxyl; linear or branched, C₁-C₆ alkyl; linear or branched, C₁-C₆ alkoxy; C(O)—R₄; and mixtures thereof. R₄ is selected from hydrogen; hydroxyl; linear or branched, substituted or unsubstituted C₁-C₆ alkyl; linear or branched, substituted or unsubstituted C₁-C₆ alkoxy and mixtures thereof, more specifically hydrogen; hydroxyl; linear or branched, C₁-C₆ alkyl and mixtures thereof more specifically hydrogen; hydroxyl, or mixtures thereof.

Nonlimiting illustrative examples of suitable reversible aromatic protease inhibitors include:

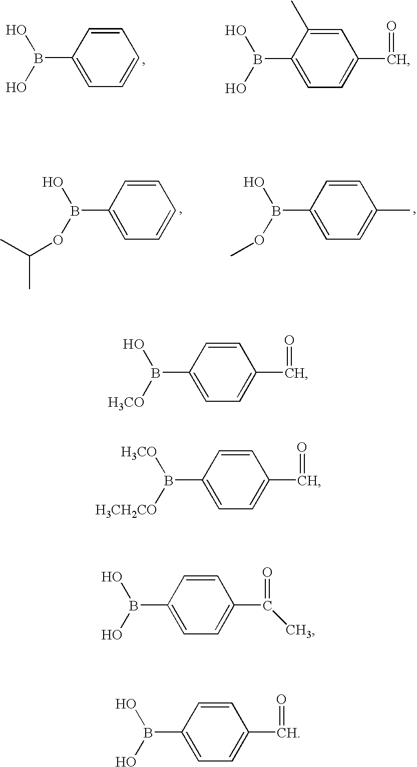

In one optional embodiment, the composition comprises, from about 0.00001% to about 5%, even more specifically from about 0.00001% to about 2%, by weight of the composition, of the reversible aromatic protease inhibitors.

Surfactants—In one embodiment the liquid detergent composition of the present invention may contain one or more surface active agents (surfactants). The surfactant may be selected from anionic, nonionic, cationic, amphoteric, zwitterionic and mixtures thereof. In one embodiment, surfactant detergents for use in the present invention are mixtures of anionic and nonionic surfactants although it is to be understood that any surfactant may be used alone or in combination with any other surfactant or surfactants. When present in the concentrated detergent composition, the surfactant may comprise, from about 0.1% to about 70%, more specifically from about 1% to about 50%, by weight of the liquid detergent composition.

Illustrative examples of surfactants useful herein are described in U.S. Pat. No. 3,664,961, U.S. Pat. No. 3,919,678, U.S. Pat. No. 4,062,647, U.S. Pat. No. 4,316,812 U.S. Pat. No. 3,630,929, U.S. Pat. No. 4,222,905, U.S. Pat. No. 4,239,659, U.S. Pat. No. 4,497,718; U.S. Pat. No. 4,285,841, U.S. Pat. No. 4,284,532, U.S. Pat. No. 3,919,678, U.S. Pat. No. 2,220,099 and U.S. Pat. No. 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M.C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch).

Nonionic surfactant, when present in the liquid detergent composition may be present in the amount of from about 0.01% to about 70%, more specifically from about 1% to about 50%, even more specifically from about 5% to about 40%, by weight of the liquid detergent composition. Illustrative examples of suitable nonionic surfactants include: alcohol ethoxylates (e.g. Neodol 25-9 from Shell Chemical Co.), alkyl phenol ethoxylates (e.g. Tergitol NP-9 from Union Carbide Corp.), alkylpolyglucosides (e.g. Glucapon 600CS from Henkel Corp.), polyoxyethylenated polyoxypropylene glycols (e.g. Pluronic L-65 from BASF Corp.), sorbitol esters (e.g. Emsorb 2515 from Henkel Corp.), polyoxyethylenated sorbitol esters (e.g. Emsorb 6900 from Henkel Corp.), alkanolamides (e.g. Alkamide DC212/SE from Rhone-Poulenc Co.), and N-alkypyrrolidones (e.g. Surfadone LP-100 from ISP Technologies Inc.); and combinations thereof.

Anionic surfactant, when present in the liquid detergent composition may be present in the amount of from about 0.01% to about 70%, more specifically from about 1% to about 50%, even more specifically from about 5% to about 40%, by weight of the liquid detergent composition. Illustrative examples of suitable anionic surfactants includes: linear alkyl benzene sulfonates (e.g. Vista C-500 commercially available from Vista Chemical Co.), branched linear alkyl benzene sulfonates (e.g. MLAS), alkyl sulfates (e.g. Polystep B-5 commercially available from Stepan Co.), branched alkyl sulfates, polyoxyethylenated alkyl sulfates (e.g. Standapol ES-3 commercially available from Stepan Co.), alpha olefin sulfonates (e.g. Witconate AOS commercially available from Witco Corp.), alpha sulfo methyl esters (e.g. Alpha-Step MCp-48 commercially available from Stepan Co.) and isethionates (e.g. Jordapon Cl commercially available from PPG Industries Inc.), and combinations thereof.

Cationic surfactant, when present in the liquid detergent composition, may be present in the amount of from about 0.01% to about 70%, more specifically from about 1% to about 50%, even more specifically from about 5% to about 40%, by weight of the liquid detergent composition. Specific cationic surfactants include C8-C18 alkyl dimethyl ammonium halides and analogs in which one or two hydroxyethyl moieties replace one or two methyl moieties.

Amphoteric surfactant, when present in the liquid detergent composition may be present in the amount of from about 0.01% to about 70%, more specifically from about 1% to about 50%, even more specifically from about 5% to about 40%, by weight of the liquid detergent composition. Examples of amphoteric surfactants are sodium 3(dodecylamino)propionate, sodium 3-(dodecylamino)propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine.

Zwitterionic surfactant, when present in the liquid detergent composition may be present in the amount of from about 0.01% to about 70%, more specifically from about 1% to about 50%, even more specifically from about 5% to about 40%, by weight of the liquid detergent composition.

Non-Protease Enzyme—The compositions and methods of the present invention may include a non-protease enzyme, specifically from about 0.00001% to about 2%, more specifically from about 0.0005% to about 1%, even more specifically from about 0.001% to about 0.5%, by weight of the detergent composition, of a non-protease enzyme.

Non-protease enzymes can be included in effective amounts in the liquid laundry cleaning composition herein for a wide variety of fabric laundering purposes, including removal of protein-based, carbohydrate-based, or triglyceride-based stains, for example and/or for fabric restoration.

Examples of suitable non-protease enzymes include, but are not limited to, hemicellulases, peroxidases, cellulases, xylanases, lipases, phospholipases, esterases, cutinases, pectinases, pectate lyases, keratanases, reductases, oxidases, phenoloxidases, lipoxygenases, ligninases, pullulanases, tannases, pentosanases, malanases, β-glucanases, mannanases, arabinosidases, hyaluronidase, chondroitinase, laccase, amylases, and combinations thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on.

A potential enzyme combination, in addition to protease, comprises a mixture of conventional detersive enzymes like lipase, cutinase cellulase and/or amylase. Another optional potential enzyme is selected from cellulases, lipases, amylases, mannanases, pectate lyases and mixtures thereof. Detersive enzymes are described in greater detail in U.S. Pat. No. 6,579,839 and WO01/02530.

A non-limiting list of suitable commercially available non-protease enzymes include: Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Cellulases include bacterial or fungal cellulases, e.g. produced by Humicola insolens, particularly DSM 1800, e.g. 50 Kda and ^{˜}43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase®, Lipolase Ultra®, Lipoprime® and Lipex® from Novozymes. Also suitable are cutinases [EC 3.1.1.50] and esterases. Also suitable are carbohydrases e.g. mannanase (U.S. Pat. No. 6,060,299), pectate lyase (WO99/27083) cyclomaltodextringlucanotransferase (WO96/33267) xyloglucanase (WO99/02663). Bleaching enzymes include e.g. peroxidases, laccases, oxygenases, (e.g. catechol 1,2 dioxygenase, lipoxygenase (WO 95/26393), (non-heme) haloperoxidases.

Adjunct Ingredients—The compositions and methods of the present invention may include an adjunct ingredient, specifically from about 0.0001% to about 95%, more specifically from about 0.001% to about 70%, by weight of the detergent composition, of an adjunct ingredient.

In one embodiment of the instant invention, the adjunct ingredient may be selected from builders, brightener, dye transfer inhibitor, chelants, polyacrylate polymers, dispersing agents, colorant dye, hueing dyes, perfumes, processing aids, bleaching additives, bleach activators, bleach precursors, bleach catalysts, solvents, co-solvents, hydrotropes, liquid carrier, phase stabilizers, soil release polymers, enzyme stabilizers, enzymes, soil suspending agents, anti-redeposition agents, deflocculating polymers, bactericides, fungicides, UV absorbers, anti-yellowing agents, anti-oxidants, optical brighteners, suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides and mixtures thereof. Further examples of suitable adjunct ingredient and levels of use are described in U.S. Pat. No. 3,936,537, issued Feb. 3, 1976 to Baskerville, Jr. et al.; U.S. Pat. No. 4,285,841, Barrat et al., issued Aug. 25, 1981; U.S. Pat. No. 4,844,824 Mermelstein et al., issued Jul. 4, 1989; U.S. Pat. No. 4,663,071, Bush et al.; U.S. Pat. No. 4,909,953, Sadlowski, et al. issued Mar. 20, 1990; U.S. Pat. No. 3,933,672, issued Jan. 20, 1976 to Bartoletta et al.; U.S. Pat. No. 4,136,045, issued Jan. 23, 1979 to Gault et al; U.S. Pat. No. 2,379,942; U.S. Pat. No. 3,308,067; U.S. Pat. No. 5,147,576 to Montague et al; British Pat. No. 1,470,250; British Patent No. 401,413 to Marriott; British Patent No. 461,221 to Marriott and Guam British Patent No. 1,429,143; and U.S. Pat. No. 4,762,645, Tucker et al, issued Aug. 9, 1988.)

Non-limiting examples of some of possible adjunct ingredients follows.

Exemplary bleaching additives include bleaches such as hydrogen peroxide, perborate, percarbonate or peroxyacids such as 6-phthalimidoperoxyhexanoic acid and mixtures thereof.

Suitable chelants include, S,S-ethylenediamine disuccinic acid (EDDS), Tiron® (otherwise know as Catechol-2,5-disulfonate as the acid or water soluble salt), ethylenediamine tetraacetic acid (EDTA), Diethylenetriaminepentaacetate (DTPA), 1-Hydroxyethylidene 1,1 diphosphonic acid (HEDP), Diethylenetriamine-penta-methylene phosphonic acid (DTPMP), dipicolinic acid and salts and/or acids thereof and mixtures thereof. Further examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

Examples of suitable builders which may be used include water-soluble alkali metal phosphates, polyphosphates, borates, silicates and also carbonates; water-soluble amino polycarboxylates; fatty acid soaps; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, silicates, and carbonates; water-soluble salts of mellitic acid, citric acid, and carboxymethyloxysuccinic acid, salts of polymers of itaconic acid and maleic acid, tartrate monosuccinate, tartrate disuccinate; and mixtures thereof.

Another optional adjunct ingredient is a thickener. Illustrative examples of thickeners include rheology modifiers, structurants and combinations thereof. Illustrative examples of structurants useful herein include methylcellulose, hydroxypropylmethylcellulose such as Methocel® trade name from Dow Chemical, xanthan gum, gellan gum, guar gum and hydroxypropyl guar gum, succinoglycan and trihydroxystearin. Other illustrative examples of structurants includes the nonpolymeric hydroxyfunctional structurants. A structurant is incorporated into a composition to establish desired rheological characteristics in a liquid product. When present these optional adjuncts are present in the compositions they are present at levels to provide the desired characteristics, specifically from about 0.01% to about 1% by weight, more specifically from about 0.015% to about 0.75% by weight, even more specifically from 0.02% to 0.5% by weight, of the compositions herein.

The nonpolymeric hydroxyfunctional structurant is selected from non-polymeric, crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes. Specific illustrative and non-limiting examples of hydroxyl-containing structurants include castor oil and its derivatives. More specifically hydrogenated castor oil derivatives such as hydrogenated castor oil and hydrogenated castor wax. Commercially available, castor oil-based, crystalline, hydroxyl-containing structurants include THIXCIN® from Rheox, Inc. See also U.S. Pat. No. 6,080,708 and PCT Publication No. WO 02/40627. Another commercially available structurant is 1,4-di-O-benzyl-D-Threitol in the R,R, and S,S forms and any mixtures, optically active or not.

The detergent compositions herein may also optionally contain low levels of materials which serve as phase stabilizers and/or co-solvents for the liquid compositions herein. Materials of this type include C₁-C₃ lower alkanols such as methanol, ethanol and/or propanol. Lower C₁-C₃ alkanolamines such as mono-, di- and triethanolamines can also be used, by themselves or in combination with the lower alkanols. If present, phase stabilizers/co-solvents can optionally comprise from about 0.1% to about 5.0% by weight of the compositions herein.

Liquid Carrier—The liquid cleaning compositions according to the present invention may also contain a liquid carrier. Typically the amount of the liquid carrier when present in the compositions herein will be relatively large, often comprising the balance of the cleaning composition, but can comprise from about 5 wt % to about 85 wt % by weight of the cleaning composition. In one embodiment low levels, 5% to 20% by weight of the cleaning composition of liquid carrier is utilized.

In another embodiment, the compositions may comprise at least about 60%, more specifically at least about 65%, even more specifically at least about 70%, even more still at least about 75%, by weight of the cleaning composition, of liquid carrier.

The most cost effective type of aqueous, non-surface active liquid carrier is, of course, water itself. In one embodiment, the water when present is selected from distilled, deionized, filtered and combinations thereof. In another embodiment, the water may be untreated.

Optional Additional Enzyme Stabilizer—In an embodiment, optional additional enzyme stabilizers may be included. These optional additional enzyme stabilizers include those known enzyme stabilizers other than the reversible peptide protease inhibitor, reversible aromatic protease inhibitor and boric acid derivative described herein. Illustrative examples of these additional optional enzyme stabilizers include any known stabilizer system like calcium and/or magnesium compounds, low molecular weight carboxylates, relatively hydrophobic organic compounds (i.e., certain esters, diakyl glycol ethers, alcohols or alcohol alkoxylates), alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compounds, polyamide oligomer, glycolic acid or its salts; poly hexa methylene bi guanide or N,N-bis-3-amino-propyl-dodecyl amine or salt; and mixtures thereof. See also U.S. Pat. No. 3,600,319, Gedge, et al., EP 0 199 405 A, Venegas, U.S. Pat. No. 3,519,570

Liquid Detergent Composition Formulation—Liquid detergent compositions can be prepared by admixing the essential and optional ingredients thereof in any desired order to provide compositions containing components in the requisite concentrations. Liquid compositions according to the present invention can also be in “compact form”, in such case, the liquid detergent compositions according to the present invention will contain a lower amount of water, compared to conventional liquid detergents.

The reversible peptide protease inhibitor and protease enzyme can be added separately in the liquid detergent composition, or can be premixed with each other before addition to the liquid detergent composition.

The liquid detergent compositions may be of any desired color or appearance, namely opaque, translucent, or transparent, such as the compositions of U.S. Pat. No. 6,630,437 to Murphy et al., issued Oct. 7, 2003. For purposes of the invention, as long as one wavelength in the visible light range has greater than 25% transmittance, it is considered to be transparent or translucent.

The compositions according to the present invention may have any suitable pH, specifically a pH of from about 5.5 to about 11, more specifically from about 6 to about 9, even more specifically from about pH from about 6 to about 8.5. The composition pH is measured as a neat solution at standard temperature and pressure, i.e. 21° C., and at 1 atmosphere pressure.

Detergent Packaging—The detergent compositions according to the present invention may be presented to the consumer in standard packaging, or may be presented in any suitable packaging. Recently, multiple compartment bottles containing multiple formulations that are dispensed and combined have become used for detergent compositions. The compositions of the present invention may be formulated for inclusion in such packages. In addition, unit dose packages have also become commonly used for detergent compositions. Such packages are also suitable for use with the compositions of the present invention.

The packaging may be of any desired color or appearance, namely opaque, translucent, transparent, or even combinations thereof. Illustrative but nonlimiting packages may be found in U.S. Pat. No. 6,630,437 to Murphy et al., issued Oct. 7, 2003.

Methods of Use—The present invention also provides a method for cleaning fabrics. Such a method employs contacting these fabrics with an aqueous washing solution formed from an effective amount of the liquid detergent compositions hereinbefore described. Contacting of fabrics with washing solution will generally occur under conditions of agitation.

Agitation is preferably provided in a washing machine for good cleaning. Washing is preferably followed by drying the wet fabric in a conventional clothes dryer. An effective amount of the liquid detergent composition in the aqueous wash solution in the washing machine may be specifically from about 500 to about 10,000 ppm, more specifically from about 2,000 to about 10,000 ppm, under typical European washing conditions and may be specifically from about 1,000 to about 3,000 ppm under typical U.S.A. washing conditions. In the newer high efficiency (HE) washing machines in the U.S.A., higher product concentrations are delivered to fabric and therefore soil and dye-loads in the wash solution are even higher. Product concentration and raw material levels are thereby adjusted to accommodate these changes in wash conditions due to washing machine changes.

### EXAMPLES

The liquid detergent compositions given in Tables 1 and 2 illustrate the invention.

TABLE 1

| | A | B | C | D |
|---|---|---|---|---|
| C₁₁₋₁₂ linear alkyl benzene sulfonic acid | 0.2 | 1.5 | 1.5 | 1.5 |
| C₁₂₋₁₅ alkyl ethoxy (EO₃) sulfate Na salt | — | 7 | — | — |
| C₁₂₋₁₅ alkyl ethoxy (EO_{1.8}) sulfate Na salt | — | — | 8 | 9 |
| C₁₄₋₁₅ ethoxylated (EO₈) alcohol | 10 | 4 | — | — |
| C₁₂₋₁₃ ethoxylated (EO₉) alcohol | — | — | 1.2 | 1.6 |
| C₁₂₋₁₄ Dimethyl Hydroxyethyl Ammonium | 1 | — | — | — |
| Chloride | | | | |
| C₁₂₋₁₄ dimethyl Amine Oxide | 1.5 | — | — | — |
| C₁₂₋₁₈ Fatty Acid | — | 2.5 | — | 0.5 |
| Citric Acid | 3 | 2.5 | 1 | 2.5 |
| Diethylene triamine penta methylenephosphonic | 0.2 | — | — | — |
| acid | | | | |
| Diethylene triamine penta acetate MW = 393 | — | — | 0.3 | 0.3 |
| Ethoxysulfated hexamethylene diamine quat¹ | 1.3 | 0.2 | — | |
| Ethoxylated Polyethyleneimine² | — | — | — | 0.35 |
| Ethoxylated tetraethylene pentamine³ | — | — | 0.4 | 0.4 |
| Ethanol | 1.5 | 1 | 2.5 | 3 |
| 1,2-Propanediol | 0.6 | — | 0.9 | — |
| Na Cumene Sulfonate | 2 | — | — | — |
| Boric acid | — | 1 | — | — |
| Borax | — | — | 1 | — |
| Ca formate | — | — | 0.1 | 0.1 |
| Na formate | — | — | 1 | 0.6 |
| Monoethanolamine | 0.8 | — | 0.9 | 2 |
| Sodium hydroxide, trim to pH | 8.4 | 8.0 | 8.2 | 8.2 |
| Protease⁴ (40 mg/g) | — | 0.5 | — | 0.35 |
| Savinase ® 16 L (Novozymes) | 0.6 | — | — | — |
| Alcalase ® 2.5 L (Novozymes) | — | — | 0.4 | — |
| Termamyl ® 300 L (Novozymes) | — | 0.05 | — | — |
| Natalase ® 200 L (Novozymes) | 0.15 | — | — | 0.06 |
| Mannanase ® 25 L (Novozymes) | 0.05 | — | — | 0.02 |
| Reversible Protease Inhibitor⁵ | 0.005 | 0.004 | 0.004 | 0.006 |
| Hydrogenated castor oil structurant | 0.5 | 0.3 | — | — |
| Catioinic silicone⁶ | 0.9 | — | — | — |
| Poly Vinyl Pyridine N-oxide MW 13KDa | — | 0.1 | — | — |
| Polymer LR400⁷ | — | 0.2 | — | — |
| Water + Minors (perfumes, etc) | Balance | Balance | Balance | Balance |
| | to 100% | to 100% | to 100 | to 100% |

¹Lutensit Z from BASF
²Lutensol FP620 from BASF
³Lutensol PG105K from BASF
⁴Protease “B” in EP251446.
⁵Reversible Protease inhibitor of structure

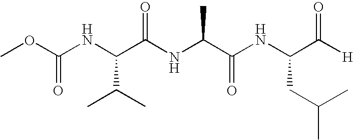

⁶Cationic silicone as per WO 2002/18528 A1
⁷Cationic cellulose polymer available from Amerchol

TABLE 2

| | E | F | G | J |
|---|---|---|---|---|
| C₁₁₋₁₂ linear alkyl benzene sulfonic acid | 8 | 8 | 8 | — |
| C₁₂₋₁₅ alkyl ethoxy (EO₃) sulfate Na salt | — | — | — | — |
| C16-18 Alkyl Sulfate Na salt | — | — | — | 0.3 |
| C₁₄₋₁₅ ethoxylated (EO₈) alcohol | 7 | 7 | 7 | — |
| C₁₂₋₁₄ ethoxylated (EO₇) alcohol | | | | — |
| C₁₂₋₁₈ ethoxylated (EO₉) alcohol | — | — | — | 14 |
| C12-14 Alkyl Poly Glycosides | — | — | — | 1 |
| C8-10 Alkyl amidopropyl dimethylamine | — | — | — | — |
| Di C16-18 alkyl ethoxymethyl ammonium | — | — | — | 1.6 |
| methosulfate | | | | |
| C₁₂₋₁₈ Fatty Acid | 2.6 | 2.6 | 2.6 | 0.5 |
| Citric Acid | 2.6 | 2.6 | 2.6 | — |
| Diethylene triamine penta methylenephosphonic | 0.2 | 0.2 | 0.2 | — |
| acid | | | | |
| Ethoxysulfated hexamethylene diamine quat¹ | 2 | 2 | 2 | — |
| Ethoxylated Polyethyleneimine² | — | — | — | — |
| Ethoxylated tetraethylene pentamine³ | — | — | — | — |
| Ethanol | 2.5 | 2.5 | 2.5 | 0.5 |
| 1,2-Propanediol | 0.8 | 0.8 | 0.8 | — |
| Isopropanol | — | — | — | 0.3 |
| Na Cumene Sulfonate | 0.5 | 0.5 | 0.5 | — |
| Boric Acid | 0.5 | — | — | — |
| Sodium formate | — | — | — | — |
| Monoethanolamine | 0.5 | 0.5 | 0.5 | — |
| Sodium hydroxide, trim to pH | 8.2 | 8.2 | 8.2 | 6.5 |
| Protease⁴ (40 mg/g) | 0.46 | 0.46 | 0.46 | 0.5 |
| Termamyl ® 300 L (Novozymes) | 0.05 | 0.05 | 0.05 | — |
| Natalase ® 200 L (Novozymes) | 0.07 | 0.07 | 0.07 | — |
| Mannanase ® 25 L (Novozymes) | 0.04 | 0.04 | 0.04 | — |
| Pectawash ® 20 L (Novozymes) | 0.11 | 0.11 | 0.11 | — |
| Carezyme ® 5 L (Novozymes) | — | 0.01 | 0.01 | — |
| CaCl2 | — | — | — | — |
| Polymer LR400⁵ | — | — | — | |
| Reversible Protease Inhibitor⁶ | 0.002 | 0.004 | 0.004 | 0.004 |
| Aromatic Protease Inhibitor⁷ | 0.001 | — | — | 0.5 |
| Hydrogenated castor oil structurant | 0.4 | 0.4 | — | — |
| Polyacrylate thickener (polygel W301) | — | — | — | — |
| Water + minors (perfume, etc) | Balance | Balance | Balance | Balance |
| | to 100% | to 100% | to 100% | to 100% |

¹Lutensit Z from BASF
²Lutensol FP620 from BASF
³Lutensol PG105K from BASF
⁴Protease “B” in EP251446.
⁵Cationic cellulose polymer available from Amerchol
⁶Reversible Protease inhibitor of structure

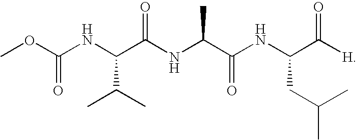

⁷Aromatic protease inhibitor of structure

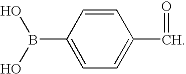

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All temperatures are in degrees Celsius (° C.) unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
(a) a surfactant;
(b) a protease enzyme;
(c) a reversible peptide protease inhibitor of the formula: 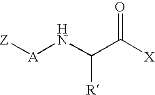
wherein A is an amino acid moiety; X is selected from H, an electron withdrawing group and mixtures thereof; and Z is a nitrogen capping moiety selected from: 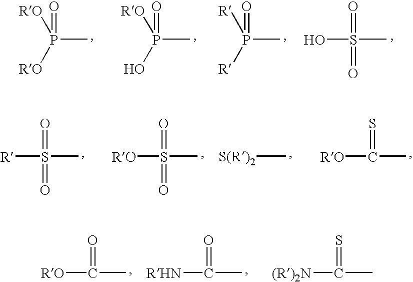
and mixtures thereof, wherein each R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof; and
wherein said liquid detergent composition comprises less than about 3%, by weight of the composition, of organic polyol solvents.

2. The composition according to claim 1, wherein A is an amino acid moiety comprising from one to four amino acids selected from Ala, Gly, Val, Ile, Leu, Phe, Lys, PGly, Phe, HPhe and mixtures thereof.

3. The composition according to claim 1, wherein said nitrogen capping moiety is selected from: 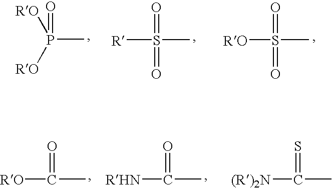
and mixtures thereof, wherein each R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof.

4. The composition according to claim 1 wherein said reversible peptide protease inhibitor is selected from: 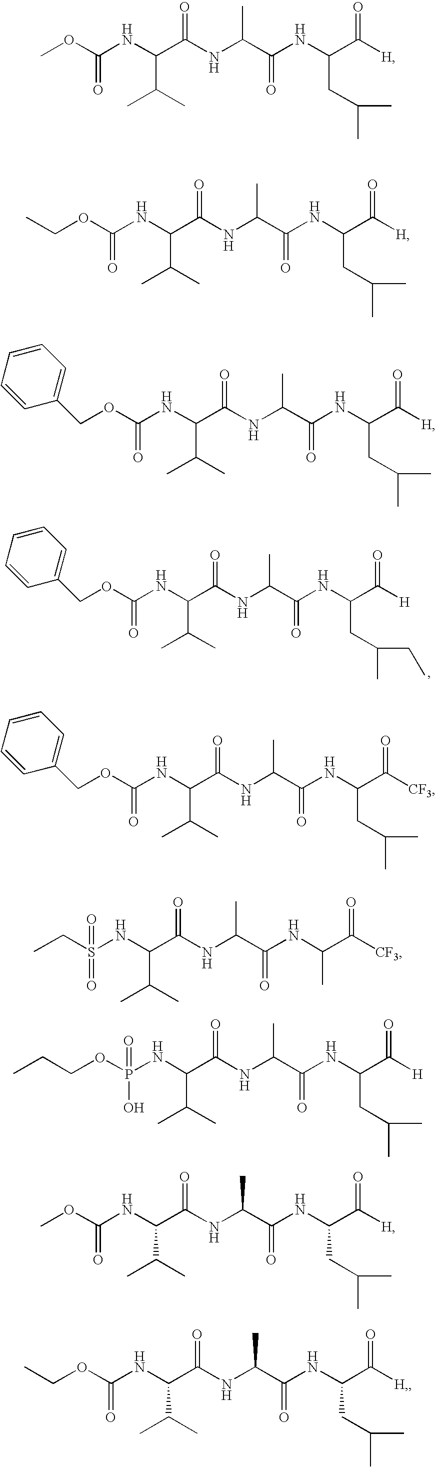 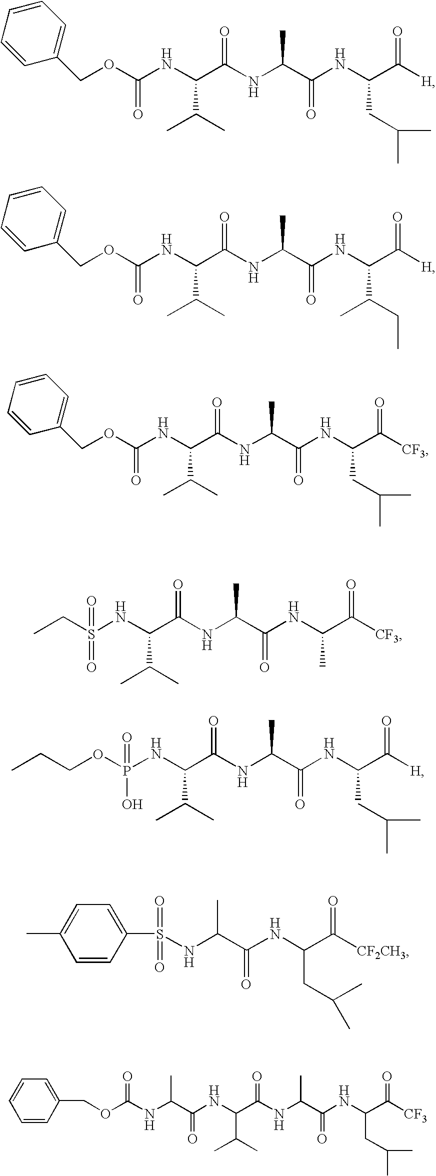
and mixtures thereof.

5. The composition according to claim 1 wherein said reversible peptide protease inhibitor has the formula:

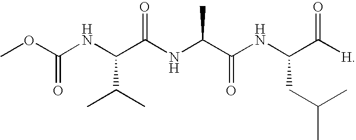

6. The composition according to claim 1 further comprising an adjunct ingredient selected from builders, brighteners, dye transfer inhibitors, structurants, fabric softening additives, chelants, polyacrylate polymers, dispersing agents, dyes, perfumes, processing aids, bleaching additives, bleach activator, bleach catalyst, solvent, non-protease enzyme, protease inhibitor other than said reversible peptide protease inhibitor (c), soil release polymers and mixtures thereof.

7. The composition according to claim 6 wherein said adjunct ingredient is a non-protease enzyme and is selected from cutinases, hemicellulases, peroxidases, cellulases, xylanases, lipases, phospholipases, esterases, pectinases, pectate lyases, keratanases, reductases, oxidases, phenoloxidases, lipoxygenases, ligninases, pullulanases, tannases, pentosanases, malanases, mannanases, β-glucanases, arabinosidases, hyaluronidase, chondroitinase, laccase, amylases and mixtures thereof.

8. The composition according to claim 1 wherein said protease enzyme is selected from serine proteases.

9. The composition according to claim 8 wherein said serine protease is selected from subtilisin proteases.

10. The composition according to claim 9 wherein said stubtilisn protease is selected from subtilisin BPN, subtilisin BPN′, subtilisin Carlsberg, subtilisin 309, subtilisin 147, subtilisin 168, subtilisin PP92, subtilisin BLAP, subtilisin K-16, their mutants and mixtures thereof.

11. A liquid detergent composition comprising:
(a) a surfactant;
(b) a protease enzyme;
(c) an enzyme stabilization system, wherein said enzyme stabilization system comprises:
a first reversible peptide protease inhibitor of the formula: 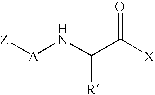
wherein A is an amino acid moiety; X is selected from H, an electron withdrawing group and mixtures thereof; and Z is a nitrogen capping moiety selected from: 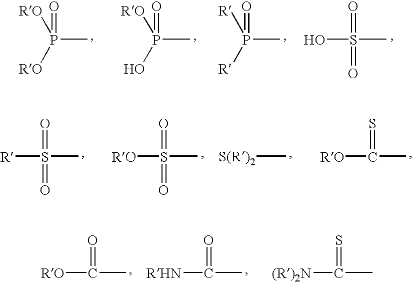
and mixtures thereof, wherein each R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof; and an aromatic protease inhibitor of the formula: 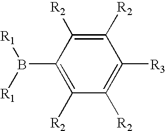
wherein each R₁ is independently selected from hydroxy; linear or branched, substituted or unsubstituted C₁-C₆ alkoxy; and mixtures thereof; each R₂ is independently selected from hydrogen; hydroxy; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; and mixtures thereof; R₃ is selected from hydrogen; hydroxyl; linear or branched, substituted or unsubstituted C₁-C₆ alkyl; linear or branched, substituted or unsubstituted C₁-C₆ alkoxy; linear or branched, substituted or unsubstituted C₁-C₆ alkenyl; C(O)—R₄ and mixtures thereof; and R₄ is selected from hydrogen; hydroxyl; linear or branched, substituted or unsubstituted C₁-C₆ alkyl; linear or branched, substituted or unsubstituted C₁-C₆ alkoxy; and mixtures thereof; and
wherein said liquid detergent composition comprises less than about 3%, by weight of the composition, of organic polyol solvents.

12. The composition according to claim 11 wherein said aromatic protease inhibitor has the formula:

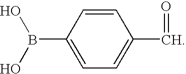

13. A liquid detergent composition comprising:
(a) a surfactant;
(b) a protease enzyme;
(c) a reversible peptide protease inhibitor of the formula: 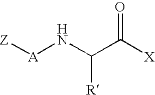
wherein A is an diamino acid moiety; X is selected from H, an electron withdrawing group and mixtures thereof; and Z is a nitrogen capping moiety selected from: 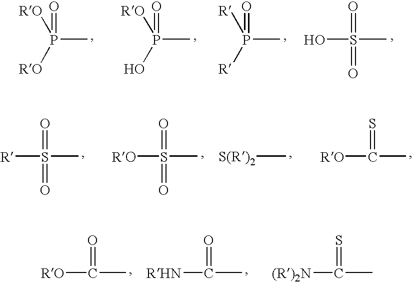
and mixtures thereof, wherein each R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof; and wherein said liquid detergent composition comprises at least one of:
(i) less than about 3%, by weight of the composition, of organic polyol solvents;
(ii) more than about 60% water;
(iii) a thickener; and/or
(iv) less than about 3%, by weight of the composition, of boric acid.

14. The composition according to claim 13, wherein A is an amino acid moiety comprising from one to four amino acids selected from Ala, Gly, Val, Ile, Leu, Phe, Lys, PGly, Phe, HPhe and mixtures thereof.

15. The composition according to claim 13, wherein said nitrogen capping moiety is selected from: 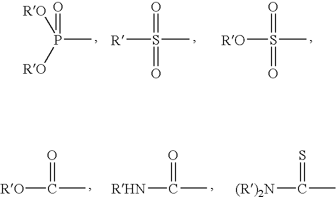
and mixtures thereof, wherein each R′ is independently selected from linear or branched, substituted or unsubstituted C₁-C₆ alkyl; phenyl; linear or branched, substituted or unsubstituted C₇-C₉ alkylaryl; and linear or branched substituted or unsubstituted C₄-C₈ cycloalkyl moieties; and mixtures thereof.

16. The composition according to claim 13 wherein said reversible peptide protease inhibitor is selected from: 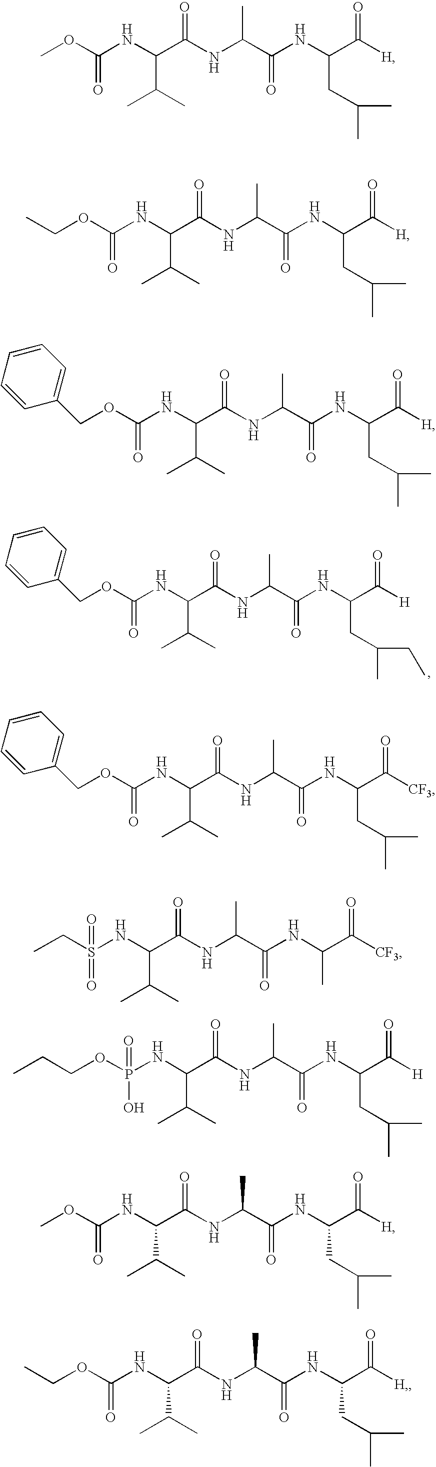 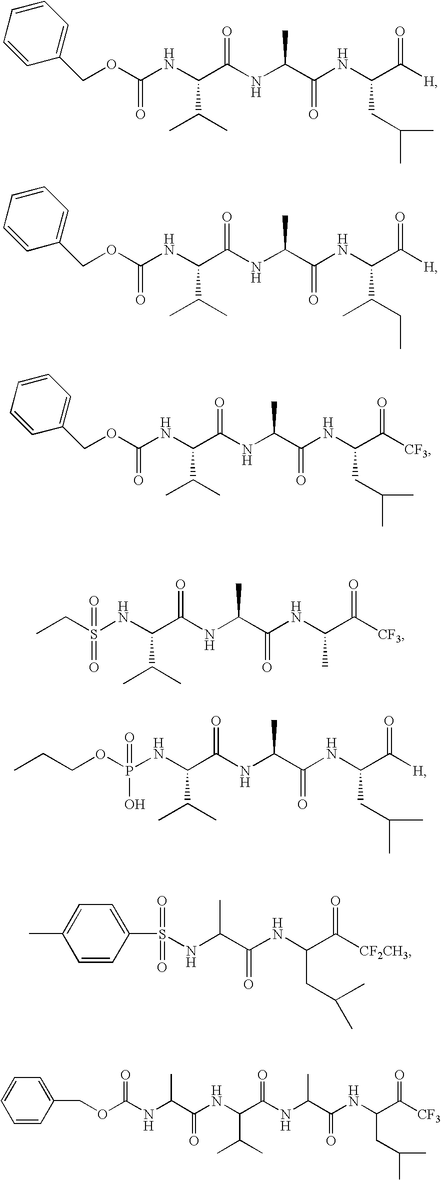
and mixtures thereof.

17. The composition according to claim 13 wherein said thickener is selected from hydrogenated castor oil derivatives and combinations thereof.

18. An article of commerce comprising
(a) a container; and
(b) a liquid laundry detergent according to claim 13 stored in said container.

19. The article of Commerce according to claim 18 wherein said liquid laundry detergent is transparent or translucent.

20. The article of Commerce according to claim 18 wherein said container is transparent or translucent.
